(19) United States
(12) Patent Application Publication
(10) Pub. No.: US 2026/0010500 A1
(43) Pub. Date: Jan. 8, 2026

(54) OFFLOADING OF ADAPTIVE ALL REDUCE OPERATIONS

(71) Applicant: Intel Corporation, Santa Clara, CA (US)

(72) Inventors: Karthik KUMAR, Chandler, AZ (US); Susanne M. BALLE, Hudson, NH (US); Marcos E. CARRANZA, Portland, OR (US); Sharanyan SRIKANTHAN, Portland, OR (US); Ishwar AGARWAL, El Dorado Hills, CA (US); Patricia M. MWOVE SHAFFER, Chandler, AZ (US); Akhilesh S. THYAGATURU, Ruskin, FL (US); Francesc GUIM BERNAT, Barcelona (ES); Thomas WILLHALM, Sandhausen (DE)

(21) Appl. No.: 19/098,621

(22) Filed: Apr. 2, 2025

Related U.S. Application Data
(63) Continuation of application No. PCT/US24/36884, filed on Jul. 5, 2024.

(51) Int. Cl. G06F 13/28

(52) U.S. Cl. CPC G06F 13/28; G06F 2213/28

(57) ABSTRACT

Examples described herein relate to a network interface device that includes: a host interface; a direct memory access (DMA) circuitry; a network interface to receive, in at least one packet, time data associated with at least one of multiple layers, wherein the multiple layers provide inputs to a collective operation associated with a large language model (LLM); and circuitry. The circuitry is to based, at least in part, on the time data associated with the multiple layers, identify a first operation of a first layer of the multiple layers as a late completing process relative to times to completion of multiple first operations of other layers and based on the first operation being identified as a late completing process, perform a remedial action to adjust at least one configuration of a first device to execute a second operation of the first layer.

### CROSS-REFERENCE TO RELATED APPLICATION

This application is a continuation of PCT/US24/36884, filed Jul. 5, 2024. The entire specification of which is hereby incorporated herein by reference in its entirety.

### BACKGROUND

Artificial intelligence (AI) models are used to analyze data to recognize patterns and make decisions with minimal human intervention. AI models continue to grow in size and complexity. Many training and inference deployments involve use of multiple graphics processing units (GPUs) in distributed multi-node and multi-rack deployments.

Large language models (LLMs) represent a class of deep learning architectures called a transformer model. A transformer model is a neural network that learns context and meaning by tracking relationships in sequential data, such as words in a sentence. A transformer is made up of multiple transformer blocks, also known as layers. For example, a transformer has self-attention layers, feed-forward layers, and normalization layers. An output of a transform layer is an input to the next transformer layer. Transformer layers work together to decipher inputs to predict streams of outputs at inference.

### BRIEF DESCRIPTION OF THE DRAWINGS

FIG. 1A depicts an example system.

FIG. 1B depicts an example system.

FIG. 2A depicts an example of telemetry distribution.

FIG. 2B depicts an example of checkpointing.

FIG. 3 depicts an example process.

FIG. 4 depicts an example process.

FIG. 5 depicts an example network interface device.

FIG. 6 depicts an example network interface device.

FIG. 7 depicts an example system.

### DETAILED DESCRIPTION

In an AI model, AllReduce is an operation that reduces results from layers or multiple processes to a single result and returns the result to the processes. AllReduce involves exchange of data through a network. Barriers allow synchronization of results among processes in a work group. A straggler thread or core can be slower than the other threads or cores and that straggler may complete processing later than other threads or cores. For both AI model training and inference, for parallel processes, stragglers can slow down completion of the reducing results from multiple processes.

For AI parameter models executing on network connected GPUs and central processing units (CPUs) or other processors, the number of messages transmitted in the network can trigger congestion, create network hotspots, and can increase the time to completion of training or inference. Moreover, the presence of late completing processes (e.g., stragglers) can further increase the time to completion of training or inference and may violate applicable service level agreements (SLAs), service level objectives (SLOs), or quality of service (QoS).

Various examples described herein provide technologies for identifying a late completing process and to reduce the time to completion of the late completing process and/or one or more subsequent processes. A late completing process can provide inputs to a collective operation, after one or more other processes that provide inputs to the collective operation. A late completing process can complete after completion of other instances of similar or same process executed by other processors. For example, a late completing process can complete one or more standard deviations after other instances of similar or same processes.

Various examples include a circuitry to track duration of execution of processes at least of an LLM as floating point operations per second (FLOPS) across time epochs or time windows and broadcasting the duration of execution of processes. Various examples include a circuitry (e.g., a network interface device or accelerator) that tracks completions of processes, determines if a process is straggler (e.g., the task provides results one or more standard deviations after other tasks provide results), and performs remediation actions for the devices that execute the straggler to speed execution of the straggler or one or more processes that follow completion of the straggler.

For example, remediation actions can include one or more of: increasing or decreasing frequencies or power supplied to core, uncore, accelerators, or input output (IO) die utilized by the straggler; adjusting cooling or heating supplied to a server or rack utilized by the straggler; or others. Accordingly, migration of a straggler process can be potentially avoided by adjusting resources utilized by the straggler process to potentially increase the speed of the straggler process so that the does not straggler process provide results on a delayed basis. However, the circuitry can cause migration of the straggler process to another device based on the circuitry identifying the straggler process as a straggler one or more additional times.

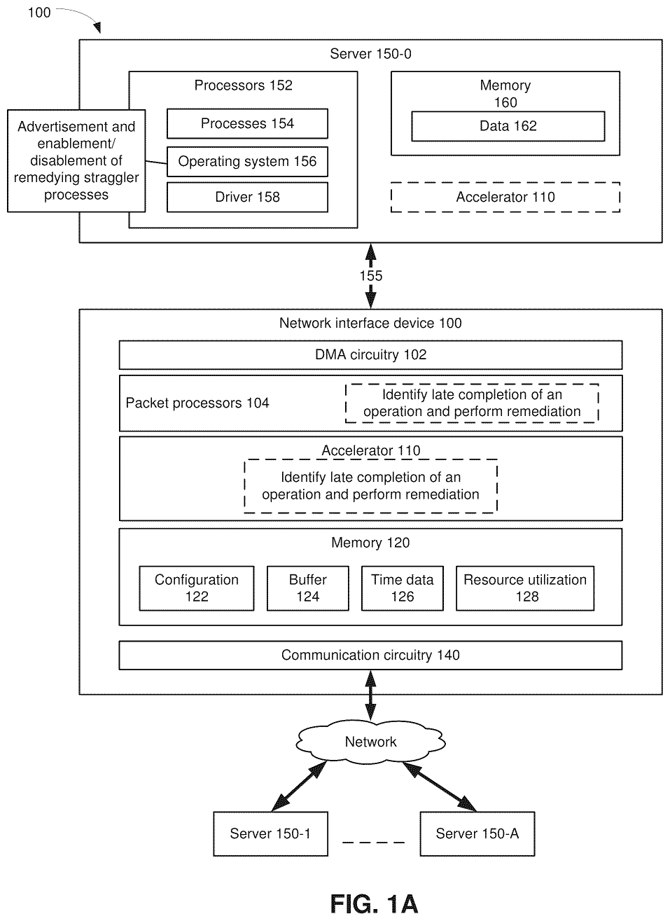

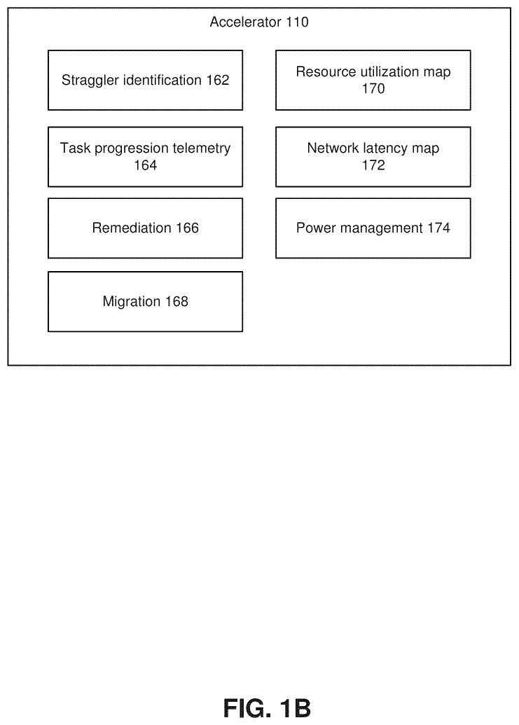

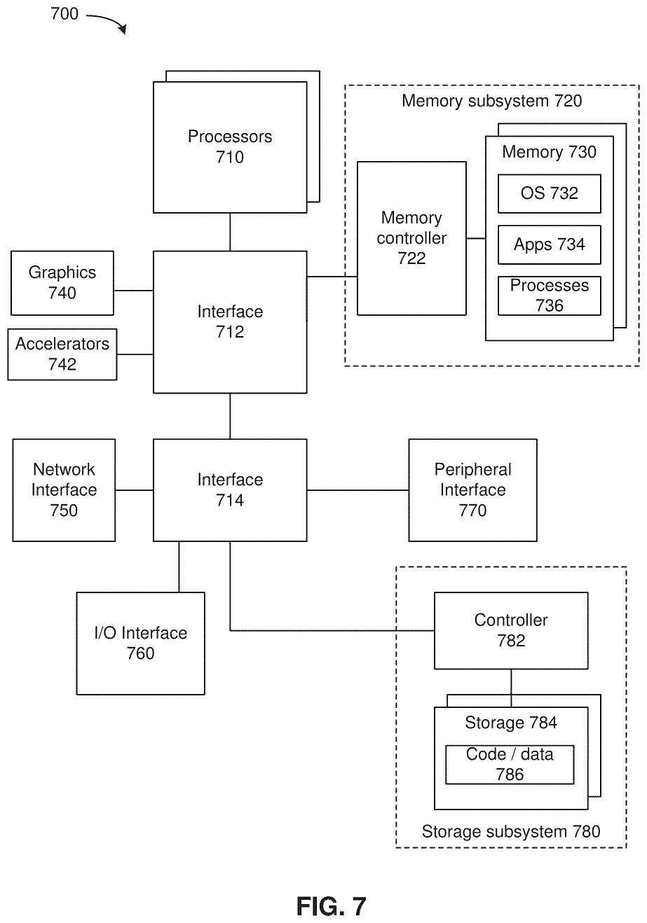

FIG. 1A depicts an example system. One or more of servers 150-0 to 150-A, where A is an integer, can be coupled to network interface device 100 using a device interface 120 (e.g., Peripheral Component Interconnect express (PCIe), Compute Express Link (CXL), or others) or network connection. One or more of servers 150-0 to 150-A can include processors 152, memory 160, and other circuitry and/or software described herein at least with respect to the system of FIG. 7. Processors 152 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry.

Processors 152 can execute processes or tasks 154. A process or task 154 can include one or more of: application, process, thread, a virtual machine (VM), microVM, container, microservice, or other virtualized execution environment. Processes 154 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Processes 154 can perform operations associated with AI or machine learning (ML) operations such as collective operations, or operations of a layer, as described herein.

Processors 152 can include a system agent or uncore that can include or more of a memory controller, a shared cache (e.g., last level cache (LLC)), a cache coherency manager, arithmetic logic units, floating point units, core or processor interconnects, Caching/Home Agent (CHA), interface circuitry (e.g., fabric, memory, device), and/or bus or link controllers. System agent can provide one or more of: direct memory access (DMA) engine connection, non-cached coherent master connection, data cache coherency between cores and arbitrates cache requests, or Advanced Microcontroller Bus Architecture (AMBA) capabilities.

Processors 152 can execute operating system 156 and/or driver 158. Processes 154 can call an application programming interface (API) to communicate with operating system 156 and/or driver 158 to discover capability of network interface device 100 to adjust resources allocated to perform collective operations or operations that provide inputs to a collective operation. Operating system 156 and/or driver 158 can enable or disable packet processors 104 and accelerator 110 of network interface device 100 to adjust resources allocated to perform collective operations or operations that provides inputs to a collective operation by configuration 122. Configuration 122 can be loaded into memory 160 of network interface device 100 by operating system 156, driver 158, or a data center administrator using an application programming interface (API), configuration file, or other communication.

Packet processors 104 and/or accelerator 110 can process data to be transmitted to server 150-0 to 150-A or received from server 150-0 to 150-A by performing one or more of: encryption, decryption, data compression, data decompression, data or device authentication, next hop determination, error value checking (e.g., cyclic redundancy check (CRC) or checksum), trust verification, or others.

Based on configuration 122, packet processors 104 can be configured to perform match-action operations on received packets to identify packet processing rules and next hops using information stored in a ternary content-addressable memory (TCAM) tables or exact match tables in some examples. Configuration 122 can be based on one or more of: OneAPI, Programming protocol independent packet processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, OpenConfig, NETCONF, RESTconf API, x86 compatible executable binaries, or other executable binaries.

In some examples, network interface device 100 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An EPU can include a network interface device that utilizes processors and accelerators (e.g., digital signal processors (DSPs), signal processors, or wireless specific accelerators for Virtualized radio access networks (vRANs), cryptographic operations, compression/decompression, and so forth). A network interface device can include: one or more processors; one or more programmable packet processing pipelines; one or more accelerators; one or more application specific integrated circuits (ASICs); one or more field programmable gate arrays (FPGAs); one or more memory devices; one or more storage devices; or others.

One or more of servers 150-0 to 150-A can output data associated with operations associated with an AI or ML model and network interface device 100 and/or one or more of servers 150-0 to 150-A can perform operations that provides inputs to a collective operation or collective operations on the data. In some examples, for network interface device 100, packet processors 104 and/or accelerator 110 can perform operations that provide inputs to a collective operation or collective operations on data received from one or more of servers 150-0 to 150-A. Examples of operations that provides inputs to a collective operation can include at least: forward pass, compute loss, backward pass, error function, loss function, update weights, ReduceScatter, AllGather, or others.

Various examples of collective operations include: broadcast (e.g., distribute data to multiple processing units), AllReduce, reduce (e.g., collect data or partial results from processors and perform an operator on the data or partial results), prefix-sum or scan operation (e.g., collect data or partial results from processors, perform an operator on the data or partial results, and provide the results of the operator to the processors), barrier (e.g., wait for processors to call a barrier), gather (e.g., store data from multiple processors on a single processor), AllGather (e.g., collect data from multiple processors and to store the collected data on the multiple processors), scatter (e.g., distribute data from a processor to multiple processors), a combination thereof, or others.

Examples of AllReduce operations can include, at least, one or more of: return the maximum element, return the minimum element (e.g., data value), sum the elements, multiply some or all of the elements, perform logical and across elements, perform logical OR across the elements, perform a bitwise and across the bits of the elements, perform a bitwise OR across the bits of the elements, return the maximum value of the elements and the rank of a process that generated the maximum value, return the minimum value of the elements and the rank of a process that generated the maximum value, or others.

In some examples, accelerator 110 can be accessible or part of a system on chip (SoC) of network interface device 100 or accessible to processors 152 as an accelerator.

One or more of servers 150-0 to 150-A and/or network interface device 100 can perform operations related to training or inference of an artificial intelligence (AI) or machine learning (ML) model such as an LLM.

In some examples, servers 150-0 to 150-A and/or network interface device 100 can independently perform an LLM and communicate results that are subject to a collective operation. An operation that provides inputs to a collective operation or a collective operation can cause a bottleneck or increase latency to completion of an iteration of an LLM. To attempt to reduce latency from an operation that provides inputs to a collective operation or a collective operation, packet processors 104 and/or accelerator 110 can identify straggler processes and attempt to reduce latency of straggler processes.

For example, server 150-0 to 150-A can provide time data associated with the operations such as duration of time to completion and FLOPs. Packet processors 104 and/or accelerator 110 can store the time data associated with the operations as time data 126. Based on time data 126, packet processors 104 and/or accelerator 110 can identify late completion of operations that provide inputs to collective processes or collective operations. As described herein, packet processors 104 and/or accelerator 110 can identify a straggler process (e.g., process that takes more time to complete or number of FLOPs than an average time to completion of at least one other process or average number of FLOPs of at least one other process) and perform a remedial action to reduce the time to completion of the straggler process, a subsequent iteration of execution of the straggler process, or one or more subsequent processes executed by the circuitry that executed the straggler process. Various examples of remedial actions include adjusting resources allocated to perform the straggler process or a subsequent process. For example, the straggler process can include a process that performs operations of a layer or a process that provides inputs to a collective operation or performs collective operations.

In some examples, processors 104 and/or accelerator 110 can orchestrate training or inference operations of an AI or ML model by selecting resources of servers 150-0 to 150-A based on device utilization in servers 150-0 to 150-A indicated in resource utilization 128 and causing such resources to perform training or inference operations of an AI or ML model. Resource utilization 128 can include one or more of: memory bandwidth, memory allocation, cache allocation, processor allocation, processor frequency, accelerator allocation, cooling, heating, or others. In some examples, processors 104 and/or accelerator 110 can perform processes that provide inputs to collective operations or collective operations and provide results of the collective operations to at least one of servers 150-0 to 150-A. In some examples, network interface device 100 can perform the collective task instead of distributing the collective tasks to servers.

In some examples, processors 104 and/or accelerator 110 can receive data from servers 150-0 to 150-A that indicate updates of available and allocated resources via heartbeat data in packets. Resource utilization data 128 can indicate a cluster-wide map that indicates resource capability and utilization (e.g., memory bandwidth utilization, memory allocation, network utilization, processor frequency, processor power utilization, device cooling capability, device heating capability, accelerator utilization, or others).

While examples are described with respect to stragglers in connection with a collective operations. examples can apply to other phases of an LLM, such as, but not limited to: first token generation, token generation, or others. A token can include an input to an LLM such as a word or other data.

Packet processors 104 and/or accelerator 110 can be implemented as one or more of: a processor core, field programmable gate array (FPGA), a processor that executes instructions, firmware, application specific integrated circuit (ASIC), or other circuitry.

Communication circuitry 112 can provide communications with other devices over a network or fabric via one or more ports. Communication circuitry 112 may be configured to use any one or more communication technology (e.g., wired or wireless communications) and associated protocols (e.g., Ethernet, InfiniBand®, Bluetooth®, Wi-Fi®, 4G LTE, 5G, Ultra Ethernet, etc.) to perform such communication. Communication circuitry 112 can include one or more network hardware resources, such as ingress queues, egress queues, crossbars, shared memory switches, media access control (MAC), physical layer interface (PHY), Ethernet port logic, and other network hardware resources.

Although examples are provided with respect to a network interface device, other devices can be used instead or in addition, such as a storage controller, memory controller, fabric interface, processor, and/or accelerator device.

FIG. 1B depicts an example system. The system can include accelerator 110 to manage performance at least of collective operations. For example, straggler identification 162 can identify a server or devices that executed a process that provided output data later than other processes provided data based on task progress telemetry 164. Task progress telemetry 164 can indicate time to generate data by processes and FLOPs utilized to generate the data. Task progress telemetry 164 can be based on telemetry data received from servers that execute processes. Remediation 166 can determine a remedial action to perform for a process identified as a straggler or that provided data later than other processes. For example, remediation 166 can utilize resource utilization map 170 and network latency map 172 to identify respective available resources in servers and available network bandwidth. Based on available device resources in one or more servers and identification of a process that has provided data later than other processes X number of times over a time window, remediation 166 can adjust resources utilized to perform a process. For example, X number of times over a time window can be set based on an applicable SLA for the LLM. For a more stringent SLA with a higher quality of service (QoS), X can be set to a lower value. By contrast, for a less stringent SLA with a lower QoS, X can be set to a higher value.

For example, for circuitry that perform a straggler process or are to perform a next iteration of the straggler process or one or more subsequent processes after the straggler process, remediation 166 can increase one or more of: memory bandwidth, memory allocation, cache allocation, processor allocation, processor frequency, accelerator allocation, cooling, heating, or others. Moreover, power management 174 can adjust power, cooling, or heating of servers that execute the process that provided data later than other processes X number of times over the time window to attempt to reduce times to completion of a next iteration of the straggler process or one or more subsequent processes after the straggler process.

In some examples, conversely, based on identification of a process that generated results substantially sooner than other processes, straggler identification 162 can determine to reduce resources available to devices allocated to perform subsequent processes.

Based on the straggler process having provided data later than other processes more than X number of times over the time window, remediation 166 can utilize migration 168 can migrate a such process to another server based on network latency map 172. For example, network latency map 172 can identify network latency among servers and a network interface device that perform operations that provide inputs to collective operations or processes that perform collective operations. Based on repeated identification of a process as a straggler, despite remediation efforts, migration 208 can select a server or composite node to migrate the process to in order to execute the process where network latency does not increase a time to providing results and where resources are available to reduce time to completion of the process based on the applicable SLA.

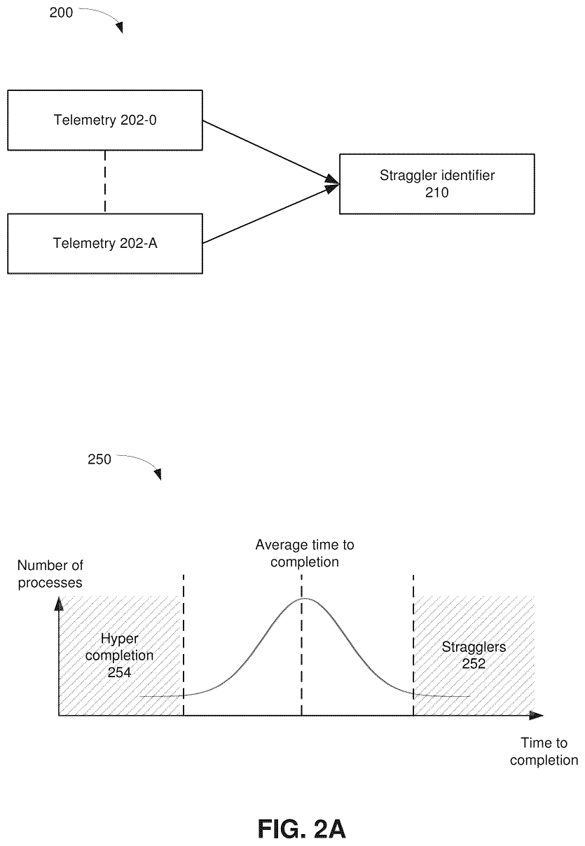

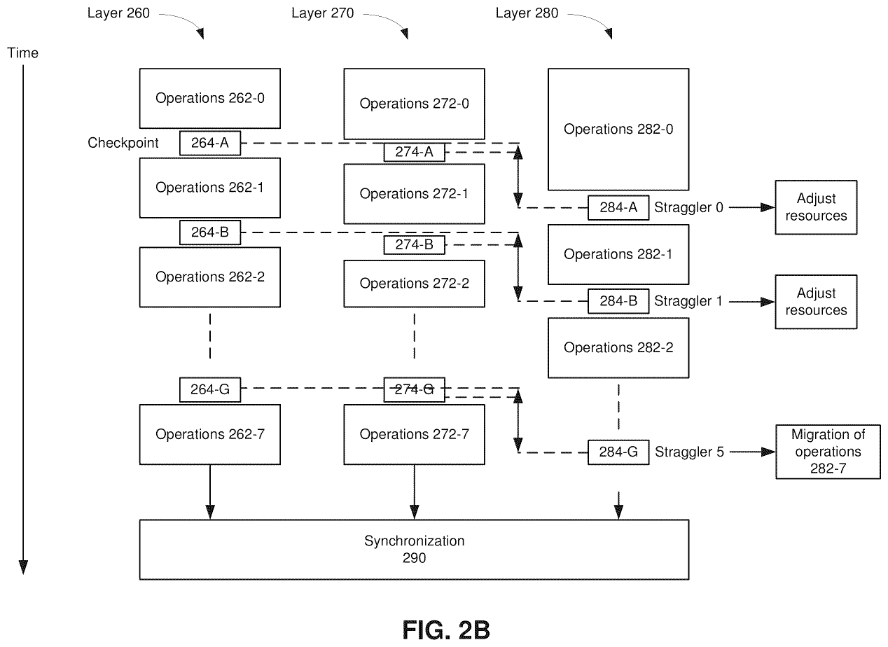

FIG. 2A depicts an example of telemetry collection and determination of stragglers. For example, based on telemetry 202-0 to 202-A, straggler identifier 210 can determine a distribution of time-to-generate data by processes associated with telemetry 202-0 to 202-A. For example, telemetry 202-0 to 202-A can include floating point operations performed per second or other examples described herein.

Based on telemetry 202-0 to 202-A, straggler identifier 210 can determine average or median time to completion of processes. Straggler identifier 210 can identify one or more processes that are stragglers 252 based on a comparison with the average or median time to completion of processes. For examples, times to completion of stragglers 252 can be one or more standard deviations more than the average or median time to completion. As described herein, device resources allocated to perform layers that provide inputs to collective processes or collective processes identified as stragglers can be increased to attempt to cause the processes to complete closer to the average time to completion.

Conversely, straggler identifier 210 can identify one or more processes that are hyper completers 254 based on a comparison with the average or median time to completion of processes. For examples, times to completion of hyper completers 254 can be one or more standard deviations less than the average or median time to completion. As described herein, device resources allocated to perform layers that provide inputs to collective processes or collective processes identified as hyper completers can be increased to attempt to cause the processes to complete closer to the average time to completion. In some examples, hyper completer processes can be migrated to another server or composite node for execution.

FIG. 2B depicts an example of determination of straggler operations or layers. Layers 260 to 280 of an LLM can perform operations that provide data that is to be synchronized at synchronization 290. In some examples, synchronization 290 can perform a collective operation.

Various examples of operations include at least: forward pass, compute loss, backward pass, error function, loss function, update weights, ReduceScatter, AllGather, or others. Examples of forward pass or forward propagation can calculate a model's predictions with true values or train data from input layer to output layer. Examples of backward pass or backward propagation can calculate a gradient using an average of a sum of losses or differences between the model's predictions and true values or train data, from output layer to input layer. Examples of an error function or loss function can include determination of one or more of: Mean Square Error (MSE)/L2 loss, Mean Absolute Error (MAE)/L1 loss, binary cross-entropy loss/log loss, categorical cross-entropy loss, hinge loss, huber loss/smooth mean absolute error, or log loss.

For example, layer 260 can process data using operations 262-0 to 262-7 and provide indicators of completions of operations at checkpoints 264-A to 264-G. For example, following completion of operation 262-0, a server or network interface device can issue an indication of completion of checkpoint A at 264-A to a network interface device that is identifying straggler processes. Similarly, following completion of operation 262-1, a server or network interface device can issue an indication of completion of checkpoint B at 264-B to a network interface device that is identifying straggler processes. Similar operations occur for checkpoints C to G.

Layers 270 and 280 can perform similar operations as those of layer 260 and also provide indications of completion of operations for checkpoints A to G to a network interface device that is to identify straggler processes.

Based on differences in receipt of times of completion of checkpoints A to G, the network interface device can identify a straggler. For example, if a timestamp of an indication of arrival at checkpoint C for layer 280 is Y % later than the average timestamps of indications of arrivals at checkpoint C for layers 260 and 270, then network interface device can perform remedial actions, described herein, to adjust resources to increase a speed of operations of operations that follow checkpoint C (e.g., one or more of operations 282-3 onward). The value of Y can be set by an orchestrator based on an SLA or QoS for the LLM. For a more stringent SLA with a higher quality of service (QoS), Y can be set to a lower value. By contrast, for a less stringent SLA with a lower QoS, Y can be set to a higher value. In some examples, an SLA or QoS can set an expected time to completion of various operations and corresponding timestamps of checkpoints A-G.

For example, by comparison of checkpoints of layers 260 and 270 with checkpoints of layer 280, layer 280 can be identified as a straggler multiple times. In some examples, after a layer is identified as a straggler, remedial actions can be performed to adjust resources allocated to perform layer 280 can be increased, as described herein. In this example, migration of operations can occur after identifying layer 280 as a straggler for N consecutive checkpoints, where N is an integer. For example, if a layer is identified as a straggler based on comparisons of timestamps of checkpoints Y times over Z number of checkpoints, migration of the layer to another server or composite node can occur. Note that should a layer be identified as completing sooner than other layers, resources allocated to the layer can be reduced so that the completion of the operations of the layer are more closely synchronized in time to completions of operations of other layer.

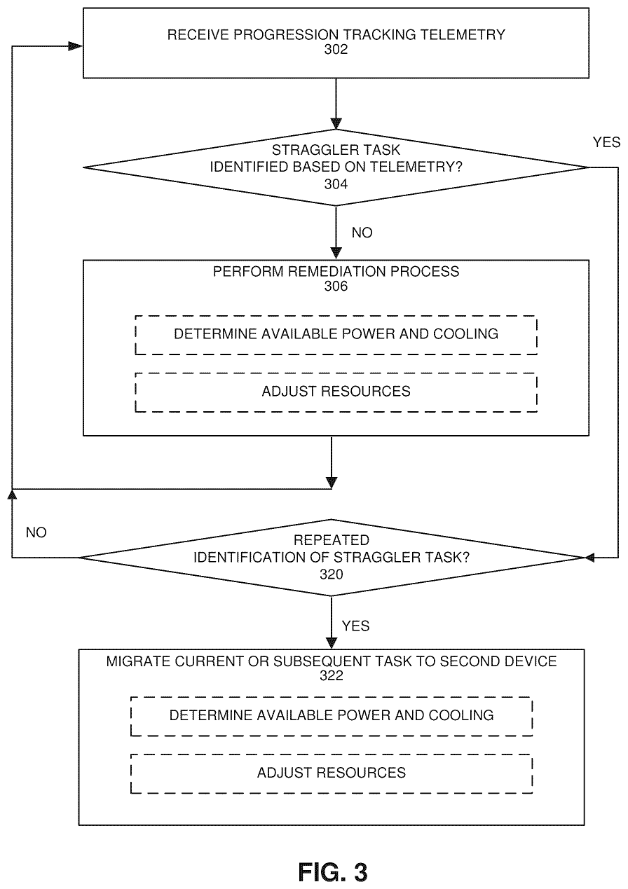

FIG. 3 depicts an example process. The process can be performed by a network interface device or accelerator. At 302, task progression tracking telemetry can be received. For example, task progression tracking telemetry can include a time to completion of operations that provide inputs to a collective operation or collective operations by one or more cores or threads. Task progression tracking telemetry can be reported per time epoch and can include a periodic record of floating point operations per second (FLOPs) for operations that provide inputs to collective operations or collective operations by one or more cores or threads. Task progression tracking telemetry can include time-to-complete operations before a checkpoint, timestamp of reaching a checkpoint, temperature of the processor that executed the operation, frequency of operation of the processor that performed the operation, power consumption to perform the operation, percentage of processor utilization to perform the operation, memory utilization to perform the operation, input/output bandwidth to perform the operation, memory bandwidth utilized to perform the operation, or others. Task progression tracking telemetry can be reported to the network interface device or accelerator. In some examples, the network interface device or accelerator can normalize task progression tracking telemetry.

At 304, a determination can be made as to whether a task (e.g., operation) is a straggler. Determination of whether a task is a straggler can be based on a mean or median time to completion of other executions of the task and a number of standard deviations from the mean or median of the time to completion of the task as well as based on task progression tracking telemetry. In some examples, based on identification of the task a straggler N number of times, the process can proceed to 306. For example, the value N can be selected to be one or more and can be tuned according to service level agreement (SLA) for an LLM so that latency of completion of an LLM or latency of a collective operation meet an applicable SLA. In some examples, based on identification of the task as a straggler more than N number of times, the process can proceed to 320.

At 306, a remediation operation can be performed to reduce a time to completion of the straggler task by a device that performs the straggler task or to attempt to reduce time to completion of one or more tasks that follow the straggler task. The device can include a server or a composed node of circuitry, including a processor, memory, network interface device, accelerator, or others. For example, a remediation operation can include one or more of: speed up processor that performs the straggler task and/or one or more tasks that follow the straggler task, increase memory and memory bandwidth allocated to a processor that performs the straggler task and/or one or more tasks that follow the straggler task, increase cooling or heating supplied to the processor and/or memory allocated to perform the straggler task and/or one or more tasks that follow the straggler task, or others.

At 320, based on repeated identification of a task as a straggler despite remedial operations, a second device can be selected to perform the task or a subsequent task. For example, the second device (in a same socket or rack as that of a device that performs the task that is identified as a straggler) can be selected based on available resources and SLA for the LLM. The second device can include a server or a composed node of circuitry, including a processor, memory, network interface device, accelerator, or others. For example, the straggler task (if not completed), subsequent iteration of the task, and/or one or more tasks that follow the straggler task can be migrated, over a device interface or network, to execute on the second device based on proximity to a processor that is to perform the straggler task (if not completed), subsequent iteration of the task, and/or one or more tasks that follow the straggler task and network load (e.g., latency of network communications between servers that communicate to perform the collective operation). Task progression tracking telemetry can be utilized to select the second device compared to the device based on: a lower temperature processor, processor with higher frequency of operation, higher power consuming processor, lower percentage of processor utilization, lower memory utilization, lower utilized input/output bandwidth, lower utilized memory bandwidth, or others. In some examples, the task can be assigned to execute on the device and the second device instead of migrating the task to the second device.

At 322, resources in the second device can be allocated to perform the migrated task or execution of a subsequent task. Power redirection commands can be issued to the system with the device that formerly executed the straggler task to reduce core frequency, turn off accelerators that perform matrix multiplication operations, reduce uncore frequency, or others. Power redirection commands can be issued to the second device that is to execute the migrated task to: increase cooling to the devices that utilize more power or execute at a higher frequency and set operating parameters of the second device to perform the migrated task to conform with applicable SLAs or QoS (e.g., processor frequency, processor power usage, memory allocation, memory bandwidth, input/output bandwidth, network interface bandwidth, or others).

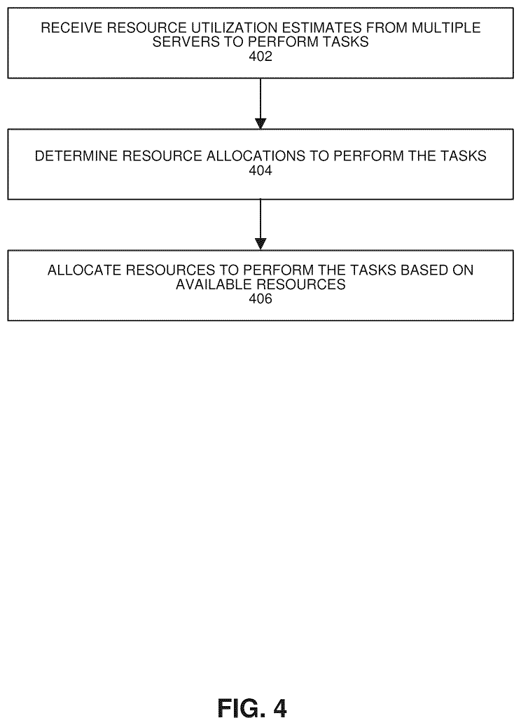

FIG. 4 depicts an example process. The process can be performed by a network interface device or accelerator, in some examples. Task execution and collective flow determination can occur before a query task associated with a collective operation of an LLM is scheduled for execution on a set of resources. At 402, the process can receive resource utilization estimates at least from an orchestrator of collective operations. For example, a network interface device and/or server can execute the orchestrator. Resource utilization estimates can be provided by servers and relate to token specific LLM and vector database queries.

At 404, the process can determine resource allocations of servers based on the estimates to perform one or more operations of a layer that provides inputs to a collective operation or to perform the collective operation. Resource allocations can be utilized by servers to perform one or more operations of a layer that provide inputs to collective operations or collective operations.

At 406, the process can allocate determined resource allocations to perform one or more operations of a layer and/or a collective operation. A topology of servers and allocated and available hardware resources in the servers to perform one or more operations of a layer that provide inputs to a collective operation or perform the collective operation can be stored in a resource utilization data. The network interface device can receive updates of allocated and available hardware resources so that the network interface device can update the resource utilization data and determine available resources to be allocated to perform one or more operations of a layer that provide inputs to a collective operation or perform the collective operation. For example, different network interface devices can periodically share with other network interface devices available network bandwidth and congestion to identify network latency that could reduce a time to receipt of data generated as an input to a collective operation or receipt of data generated by a collective operation.

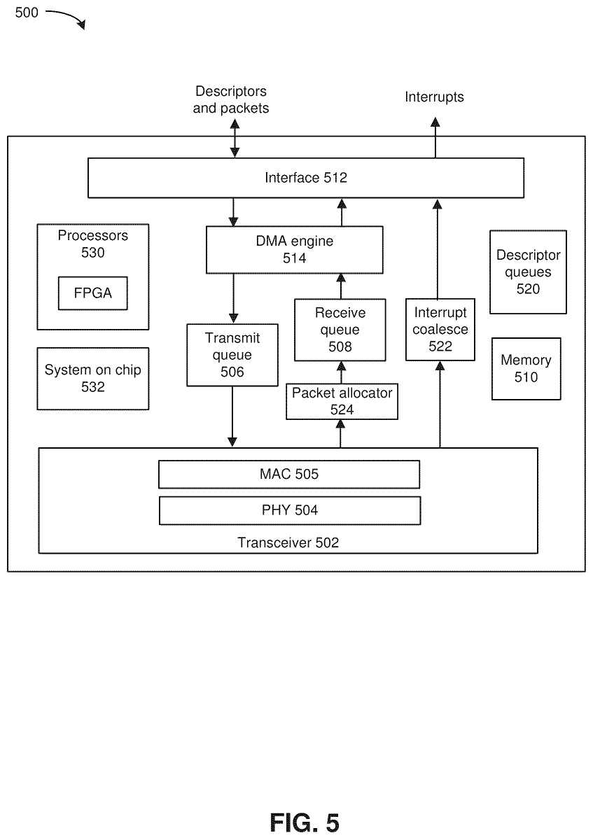

FIG. 5 depicts an example network interface device. In some examples, processors and/or FPGAs 530 can be configured to identify a straggler process and perform a remedial action to reduce a time to completion of the straggler process or at least one subsequent process to adjust resources allocated to an early finishing process or at least one subsequent process, as described herein. Some examples of network interface 500 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable circuitries or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 530, transmit queue 506, receive queue 508, memory 510, and host interface 512, and DMA engine 514. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 504 and media access control (MAC) circuitry 505. PHY circuitry 504 can include encoding and decoding circuitry (not shown) to encode and decode data packets according to applicable physical layer specifications or standards. MAC circuitry 505 can be configured to perform MAC address filtering on received packets, process MAC headers of received packets by verifying data integrity, remove preambles and padding, and provide packet content for processing by higher layers. MAC circuitry 505 can be configured to assemble data to be transmitted into packets, that include destination and source addresses along with network control information and error detection hash values.

Processors 530 can be one or more of: combination of: a processor, core, graphics processing unit (GPU), field programmable gate array (FPGA), application specific integrated circuit (ASIC), or other programmable hardware device that allow programming of network interface 500. For example, a “smart network interface” or SmartNIC can provide packet processing capabilities in the network interface using processors 530.

Processors 530 can include a programmable processing pipeline or offload circuitries that is programmable by P4, Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be utilized for packet processing or packet modification. Ternary content-addressable memory (TCAM) can be used for parallel match-action or look-up operations on packet header content. Processors 530 can be configured to identify a straggler process and perform a remedial action to reduce the time to completion of the straggler process or to adjust resources allocated to an early finishing process and/or at least one subsequent process, as described herein.

Packet allocator 524 can provide distribution of received packets for processing by multiple CPUs or cores using receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 514 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be volatile and/or non-volatile memory device and can store any queue or instructions used to program network interface 500. Transmit traffic manager can schedule transmission of packets from transmit queue 506. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with or based at least in part on PCI, PCIe, PCI-x, Serial ATA, and/or USB (although other interconnection standards may be used), or proprietary variations thereof.

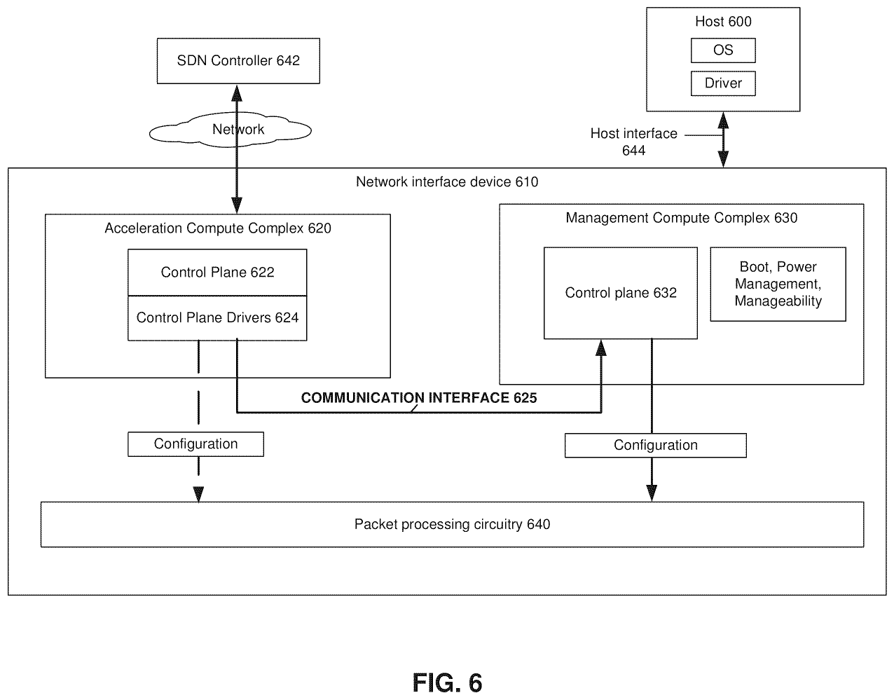

FIG. 6 depicts an example network interface device. Host 600 can include processors, memory devices, device interfaces, as well as other circuitry, such as those described herein. Processors of host 600 can execute software such as applications (e.g., microservices, virtual machine (VMs), microVMs, containers, processes, threads, or other virtualized execution environments), operating system (OS), and device drivers. An OS or device driver can configure network interface device or packet processing device 610 to identify a straggler process and perform a remedial action to reduce the time to completion of the straggler process, one or more processes that follow the straggler process, or to adjust resources allocated to an early finishing processes or one or more processes that follow the early finishing process, as described herein.

Packet processing device 610 can include multiple compute complexes, such as an Acceleration Compute Complex (ACC) 620 and Management Compute Complex (MCC) 630, as well as packet processing circuitry 640 and network interface technologies for communication with other devices via a network. ACC 620 can be implemented as one or more of: a microprocessor, processor, accelerator, field programmable gate array (FPGA), application specific integrated circuit (ASIC) or circuitry described at least with respect to herein. Similarly, MCC 630 can be implemented as one or more of: a microprocessor, processor, accelerator, field programmable gate array (FPGA), application specific integrated circuit (ASIC) or circuitry described herein. In some examples, ACC 620 and MCC 630 can be implemented as separate cores in a CPU, different cores in different CPUs, different processors in a same integrated circuit, different processors in different integrated circuit.

Packet processing device 610 can be implemented as one or more of: a microprocessor, processor, accelerator, field programmable gate array (FPGA), application specific integrated circuit (ASIC) or circuitry described herein. Packet processing circuitry 640 can process packets as directed or configured by one or more control planes executed by multiple compute complexes. In some examples, ACC 620 and MCC 630 can execute respective control planes 622 and 632.

Packet processing device 610, ACC 620, and/or MCC 630 can be configured to adjust resources allocated to a straggler or early finishing operations as well as one or more subsequent processes, as described herein.

SDN controller 642 can upgrade or reconfigure software executing on ACC 620 (e.g., control plane 622 and/or control plane 632) through contents of packets received through packet processing device 610. In some examples, ACC 620 can execute control plane operating system (OS) (e.g., Linux) and/or a control plane application 622 (e.g., user space or kernel modules) used by SDN controller 642 to configure operation of packet processing circuitry 640. Control plane application 622 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 642 can communicate with ACC 620 using a remote procedure call (RPC) such as Google remote procedure call (gRPC) or other service and ACC 620 can convert the request to target specific protocol buffer (protobuf) request to MCC 630. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 642 can provide packet processing rules for performance by ACC 620. For example, ACC 620 can program table rules (e.g., header field match and corresponding action) applied by packet processing circuitry 640 based on change in policy and changes in VMs, containers, microservices, applications, or other processes. ACC 620 can be configured to provide network policy as flow cache rules into a table to configure operation of packet processing 640. For example, the ACC-executed control plane application 622 can configure rule tables applied by packet processing circuitry 640 with rules to define a traffic destination based on packet type and content. ACC 620 can program table rules (e.g., match-action) into memory accessible to packet processing circuitry 640 based on change in policy and changes in VMs.

For example, ACC 620 can execute a virtual switch such as vSwitch or Open vSwitch (OVS), Stratum, or Vector Packet Processing (VPP) that provides communications between virtual machines executed by host 600 or with other devices connected to a network. For example, ACC 620 can configure packet processing circuitry 640 as to which VM is to receive traffic and what kind of traffic a VM can transmit. For example, packet processing circuitry 640 can execute a virtual switch such as vSwitch or Open vSwitch that provides communications between virtual machines executed by host 600 and packet processing device 610.

MCC 630 can execute a host management control plane, global resource manager, and perform hardware registers configuration. Control plane 632 executed by MCC 630 can perform provisioning and configuration of packet processing circuitry 640. For example, a VM executing on host 600 can utilize packet processing device 610 to receive or transmit packet traffic. MCC 630 can execute boot, power, management, and manageability software (SW) or firmware (FW) code to boot and initialize the packet processing device 610, manage the device power consumption, provide connectivity to Baseboard Management Controller (BMC), and other operations.

One or both control planes of ACC 620 and MCC 630 can define traffic routing table content and network topology applied by packet processing circuitry 640 to select a path of a packet in a network to a next hop or to a destination network-connected device. For example, a VM executing on host 600 can utilize packet processing device 610 to receive or transmit packet traffic.

ACC 620 can execute control plane drivers to communicate with MCC 630. At least to provide a configuration and provisioning interface between control planes 622 and 632, communication interface 625 can provide control-plane-to-control plane communications. Control plane 632 can perform a gatekeeper operation for configuration of shared resources. For example, via communication interface 625, ACC control plane 622 can communicate with control plane 632 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (phy) configuration, or perform system provisioning for different deployments of network interface device such as: storage node, tenant hosting node, microservices backend, compute node, or others.

Communication interface 625 can be utilized by a negotiation protocol and configuration protocol running between ACC control plane 622 and MCC control plane 632. Communication interface 625 can include a general purpose mailbox for different operations performed by packet processing circuitry 640. Examples of operations of packet processing circuitry 640 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 625 can include one or more mailboxes accessible as registers or memory addresses. For communications from control plane 622 to control plane 632, communications can be written to the one or more mailboxes by control plane drivers 624. For communications from control plane 632 to control plane 622, communications can be written to the one or more mailboxes. Communications written to mailboxes can include descriptors which include message opcode, message error, message parameters, and other information. Communications written to mailboxes can include defined format messages that convey data.

Communication interface 625 can provide communications based on writes or reads to particular memory addresses (e.g., dynamic random access memory (DRAM)), registers, other mailbox that is written-to and read-from to pass commands and data. To provide for secure communications between control planes 622 and 632, registers and memory addresses (and memory address translations) for communications can be available only to be written to or read from by control planes 622 and 632 or cloud service provider (CSP) software executing on ACC 620 and device vendor software, embedded software, or firmware executing on MCC 630. Communication interface 625 can support communications between multiple different compute complexes such as from host 600 to MCC 630, host 600 to ACC 620, MCC 630 to ACC 620, baseboard management controller (BMC) to MCC 630, BMC to ACC 620, or BMC to host 600.

Packet processing circuitry 640 can be implemented using one or more of: application specific integrated circuit (ASIC), field programmable gate array (FPGA), processors executing software, or other circuitry. Control plane 622 and/or 632 can configure packet processing circuitry 640 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 620 or MCC 630. In some examples, a P4 program can be compiled and provided to MCC 630 to configure packet processing circuitry 640.

FIG. 7 depicts a system. In some examples, circuitry of system 700 can configure network interface device 750 to adjust resources allocated to a straggler or early finishing process and/or one or more subsequent processes, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 732, a system administrator, and/or orchestrator can enable or disable network interface 750 to adjust resources allocated to a straggler or early finishing process and/or one or more subsequent processes, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), data processing unit (DPU), EPU, or others.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Arca RDMA Protocol (iWARP), Transmission Control Protocol (TCP), User Datagram Protocol (UDP), quick UDP Internet Connections (QUIC), RDMA over Converged Ethernet (RoCE), RoCE v2, Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 700 can be implemented using interconnected compute platforms of processors, memories, storages, network interfaces, and other components. High speed interconnects can be used such as PCIe, CXL, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a network interface device comprising: a host interface; a direct memory access (DMA) circuitry; a network interface to receive, in at least one packet, time data associated with at least one of multiple layers, wherein the multiple layers provide inputs to a collective operation associated with a large language model (LLM); and circuitry to: based, at least in part, on the time data associated with at least one of multiple layers, identify a first operation of a first layer of the multiple layers as a late completing process relative to times to completion of multiple operations of other layers of the multiple layers and based on the first operation being identified as a late completing process, perform a remedial action to adjust at least one configuration of a first device to execute a second operation of the first layer.

Example 2 includes one or more examples, wherein the first device comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

Example 3 includes one or more examples, wherein the at least one configuration of the first device comprises one or more of: memory bandwidth, memory allocation, cache allocation, power allocation to a processor, or processor clock frequency.

Example 4 includes one or more examples, wherein at least one of the time data associated with at least one of multiple layers comprises a time to complete the first operation of the first layer and/or number of floating point operations per second to complete the first operation of the first layer.

Example 5 includes one or more examples, wherein the circuitry is to: based on the first operation of the first layer being identified as a late completing process after performance of the remedial action, select a second device and cause a migration of the first operation of the first layer to the second device, wherein the select the second device is based on network bandwidth telemetry provided by at least one other network interface device.

Example 6 includes one or more examples, wherein the host interface is to receive time data associated with a second group of multiple layers, wherein the second group of multiple layers provide inputs to the collective operation and wherein the circuitry is to: based, at least in part, on the time data associated with at least one of multiple layers and the time data associated with the second group of multiple layers, identify a first operation of a second layer of the multiple layers as a late completing process and based on the first operation of the second layer being identified as a late completing process, perform a remedial action to adjust at least one configuration of a second device to execute a second operation of the second layer.

Example 7 includes one or more examples, wherein the collective operation comprises one or more of: broadcast, AllReduce, reduce, barrier, AllGather, or scatter.

Example 8 includes one or more examples, and includes at least one non-transitory computer-readable medium, comprising instructions stored thereon, that if executed by one or more processors, cause the one or more processors to: configure a network interface device to: based on identification of a first operation of a first layer as a straggler, perform a remedial action to adjust at least one configuration of circuitry for performance of a second operation of the first layer, wherein the first layer is to provide an input to an collective operation associated with a large language model (LLM).

Example 9 includes one or more examples, wherein the circuitry comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

Example 10 includes one or more examples, wherein the perform the remedial action to adjust at least one configuration of circuitry comprises increase one or more of: memory bandwidth, memory allocation, cache allocation, power allocation to a processor, processor clock frequency, decomposition of an operation to execute on multiple devices, or migration of the operation to a second device.

Example 11 includes one or more examples, and includes instructions stored thereon, that if executed by one or more processors, cause the one or more processors to: configure the network interface device to: based on identification of a third operation of the first layer as an early completing operation, perform a second remedial action to adjust at least one configuration of circuitry for performance of the third operation of the first layer, wherein the perform the second remedial action to adjust at least one configuration of circuitry comprises reduce one or more of: memory bandwidth, memory allocation, cache allocation, power allocation to a processor, or processor clock frequency.

Example 12 includes one or more examples, and includes instructions stored thereon, that if executed by one or more processors, cause the one or more processors to: configure the network interface device to: identify the first operation as a late completing operation based on a time to completion of the first operation relative to times to completion of multiple operations of other layers.

Example 13 includes one or more examples, wherein the times to completion of multiple operations of other layers comprise an aggregation of the times to completions of the multiple first operations of other layers.

Example 14 includes one or more examples, wherein the network interface device is to receive the times to completion of multiple first operations of other layers through a host interface or a network interface.

Example 15 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

Example 16 includes one or more examples, and includes a computer-implemented method comprising: identifying a first operation of a first layer as a late completing operation based on a time to completion of the first operation relative to times to completion of multiple operations of other layers and based on identification of the first operation as a late completing operation, adjusting at least one configuration of circuitry to perform a second operation of the first layer.

Example 17 includes one or more examples, wherein the circuitry comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

Example 18 includes one or more examples, wherein the at least one configuration of the circuitry comprises one or more of: memory bandwidth, memory allocation, cache allocation, power allocation to a processor, or processor clock frequency.

Example 19 includes one or more examples, wherein the times to completion of multiple operations of other layers comprise a number of floating point operations per second to complete the multiple operations of other layers.

Example 20 includes one or more examples, and includes identifying a second operation of the first layer as an early completing operation based on a time to completion of the second operation relative to times to completion of multiple second operations of other layers and based on identification of the second operation as an early completing operation, adjusting at least one configuration of circuitry to perform a third operation of the first layer.

1. An apparatus comprising:
a network interface device comprising:
a host interface;
a direct memory access (DMA) circuitry;
a network interface to receive, in at least one packet, time data associated with at least one of multiple layers, wherein the multiple layers provide inputs to a collective operation associated with a large language model (LLM); and
circuitry to:
based, at least in part, on the time data associated with at least one of multiple layers, identify a first operation of a first layer of the multiple layers as a late completing process relative to times to completion of multiple operations of other layers of the multiple layers and
based on the first operation being identified as a late completing process, perform a remedial action to adjust at least one configuration of a first device to execute a second operation of the first layer.

2. The apparatus of claim 1, wherein the first device comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

3. The apparatus of claim 1, wherein the at least one configuration of the first device comprises one or more of: memory bandwidth, memory allocation, cache allocation, power allocation to a processor, or processor clock frequency.

4. The apparatus of claim 1, wherein at least one of the time data associated with at least one of multiple layers comprises a time to complete the first operation of the first layer and/or number of floating point operations per second to complete the first operation of the first layer.

5. The apparatus of claim 1, wherein the circuitry is to:
based on the first operation of the first layer being identified as a late completing process after performance of the remedial action, select a second device and cause a migration of the first operation of the first layer to the second device, wherein the select the second device is based on network bandwidth telemetry provided by at least one other network interface device.

6. The apparatus of claim 1, wherein the host interface is to receive time data associated with a second group of multiple layers, wherein the second group of multiple layers provide inputs to the collective operation and wherein the circuitry is to:
based, at least in part, on the time data associated with at least one of multiple layers and the time data associated with the second group of multiple layers, identify a first operation of a second layer of the multiple layers as a late completing process and
based on the first operation of the second layer being identified as a late completing process, perform a remedial action to adjust at least one configuration of a second device to execute a second operation of the second layer.

7. The apparatus of claim 1, wherein the collective operation comprises one or more of: broadcast, AllReduce, reduce, barrier, AllGather, or scatter.

8. At least one non-transitory computer-readable medium, comprising instructions stored thereon, that if executed by one or more processors, cause the one or more processors to:
configure a network interface device to:
based on identification of a first operation of a first layer as a straggler, perform a remedial action to adjust at least one configuration of circuitry for performance of a second operation of the first layer, wherein the first layer is to provide an input to an collective operation associated with a large language model (LLM).

9. The at least one non-transitory computer-readable medium of claim 8, wherein the circuitry comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

10. The at least one non-transitory computer-readable medium of claim 8, wherein the perform the remedial action to adjust at least one configuration of circuitry comprises increase one or more of: memory bandwidth, memory allocation, cache allocation, power allocation to a processor, processor clock frequency, decomposition of an operation to execute on multiple devices, or migration of the operation to a second device.

11. The at least one non-transitory computer-readable medium of claim 8, comprising instructions stored thereon, that if executed by one or more processors, cause the one or more processors to:
configure the network interface device to:
based on identification of a third operation of the first layer as an early completing operation, perform a second remedial action to adjust at least one configuration of circuitry for performance of the third operation of the first layer, wherein the perform the second remedial action to adjust at least one configuration of circuitry comprises reduce one or more of: memory bandwidth, memory allocation, cache allocation, power allocation to a processor, or processor clock frequency.

12. The at least one non-transitory computer-readable medium of claim 8, comprising instructions stored thereon, that if executed by one or more processors, cause the one or more processors to:
configure the network interface device to:
identify the first operation as a late completing operation based on a time to completion of the first operation relative to times to completion of multiple operations of other layers.

13. The at least one non-transitory computer-readable medium of claim 12, wherein the times to completion of multiple operations of other layers comprise an aggregation of the times to completions of the multiple first operations of other layers.

14. The at least one non-transitory computer-readable medium of claim 12, wherein the network interface device is to receive the times to completion of multiple first operations of other layers through a host interface or a network interface.

15. The at least one non-transitory computer-readable medium of claim 8, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

16. A computer-implemented method comprising:
identifying a first operation of a first layer as a late completing operation based on a time to completion of the first operation relative to times to completion of multiple operations of other layers and
based on identification of the first operation as a late completing operation, adjusting at least one configuration of circuitry to perform a second operation of the first layer.

17. The method of claim 16, wherein the circuitry comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

18. The method of claim 16, wherein the at least one configuration of the circuitry comprises one or more of: memory bandwidth, memory allocation, cache allocation, power allocation to a processor, or processor clock frequency.

19. The method of claim 16, wherein the times to completion of multiple operations of other layers comprise a number of floating point operations per second to complete the multiple operations of other layers.

20. The method of claim 16, comprising:
identifying a second operation of the first layer as an early completing operation based on a time to completion of the second operation relative to times to completion of multiple second operations of other layers and
based on identification of the second operation as an early completing operation, adjusting at least one configuration of circuitry to perform a third operation of the first layer.
